(19) United States
(12) Patent Application Publication
(10) Pub. No.: US 2005/0073970 A1
(43) Pub. Date: Apr. 7, 2005

(54) Wireless communications network management system

(76) Inventors: Darren J. Davidson, Aurora, IL (US); Russell Dearnley, Naperville, IL (US); Andrew Gray, Orland Hills, IL (US); Shirley M. Hallmark, Sachse, TX (US); Kevin E. Linehan, Lemont, IL (US); Bobby W. Webb, Allen, TX (US)

Correspondence Address: LOCKE LIDDELL & SAPP LLP;ATTN: SUE COTT, 2200 ROSS AVENUE, SUITE 2200, DALLAS, TX, 75201-6776, US

(21) Appl. No.: 10/759,024

(22) Filed: Jan. 20, 2004

Related U.S. Application Data
(60) Provisional application No. 60/507,102, filed on Oct. 1, 2003.

(51) Int. Cl. H04Q 7/00

(52) U.S. Cl. 370/328

(57) ABSTRACT

A wireless network management system for controlling a network of antennas including multiple antennas located at multiple sites includes a controller remotely located from the network of antennas for generating an internet protocol address and establishing an internet protocol connection to a data network in communication with the network of antennas. The controller provides control signals for controlling antenna operating parameters for each of the antennas at each of the multiple sites. The system further includes a user interface coupled to the controller for selecting ones of the antennas and establishing selected antenna operating parameters based upon the creation of a group of antennas and a created schedule.

### CROSS-REFERENCE TO RELATED APPLICATION

This application claims the benefit of U.S. Provisional Application Ser. No. 60/507,102, filed Oct. 1, 2003 and entitled “Antenna Network Management System”.

### TECHNICAL FIELD OF THE INVENTION

The present invention relates to antenna control systems, and more particularly to a network management system to monitor and control a network of base station antennas and related equipment at cell sites.

### BACKGROUND OF THE INVENTION

Cellular networks utilize network parameters to control communications throughout the network. Such parameters are to typically optimized based on dynamic communications and network conditions, such as traffic load and balancing conditions and/or changing interference conditions. Typically, network parameters are fixed at the time the network is deployed. The network parameters selected are adjusted to achieve an acceptable compromise between conditions from all the varying traffic conditions that may be experienced in the network. As such, the selected parameters involve trade offs in performance and are not optimized for each geographic area or every given time of day or traffic load condition that may exist. This approach yields a static type of network plan and network optimization which does not take into account varying traffic conditions and varying interference conditions that the network will be subject to on a daily or hourly basis.

Cellular networks are subject to highly time variable traffic loads. The performance of code division multiple access networks, where users share the same frequency, is very sensitive to traffic density as a function of geographic location as well as the amount of interference that is present in the network. Accordingly, system operators typically notice increases in the drop call rate in specific locations or network performance problems in specific locations, as the traffic flow changes based on time of day, day of week, or specific traffic hot spots associated with, for example, sporting events or traffic jams. Therefore, the localized traffic handling ability of the network should be changed based on how the users are distributed.

Therefore, a need exists for a network management system for controlling antenna operating parameters such as, for example, beam elevation, azimuth beam width, elevation beam width, and azimuth beam pointing which can be controlled in real time or on a dynamic basis as traffic patterns or interference patterns change. There exists a need for a system and method for dynamically adjusting network antenna operating parameters as well as for adjusting network parameters for a particular portion of a network based on localized conditions.

### SUMMARY OF THE INVENTION

In accordance with one aspect of the present invention, a network management system for controlling a network of antennas including multiple antennas located at multiple sites is provided. The system includes a controller remotely located from the network of antennas for generating an internet protocol address and establishing an internet protocol connection to a data network in communication with the network of antennas. The controller provides control signals for controlling antenna operating parameters for each of the antennas at each of the multiple sites. The system further includes a user interface coupled to the controller for selecting ones of the antennas and establishing selected antenna operating parameters based upon the creation of a group of antennas and a created schedule.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 illustrates a block diagram of the present wireless communications network management system;

FIG. 2 is a graphical illustration of a screen display illustrating a representation of an antenna network;

FIG. 3 is a graphical illustration of a screen display illustrating a representation of multiple antennas at a network site;

FIG. 4 is a graphical illustration of a screen display illustrating the creation of a group of antennas within the antenna network;

FIG. 5 is a graphical illustration of a screen display illustrating the selection of antenna operating parameters for a group of antennas within the antenna network;

FIG. 6 is a graphical illustration of a screen display illustrating the creation of a schedule for the control of a group of antennas within the antenna network;

FIG. 7 is a graphical illustration of a screen display illustrating execution of a schedule for the control of a selected group of antennas within the antenna network; and

FIG. 8 illustrates a block diagram of the present system including network optimization.

### DESCRIPTION OF THE PREFERRED EMBODIMENTS

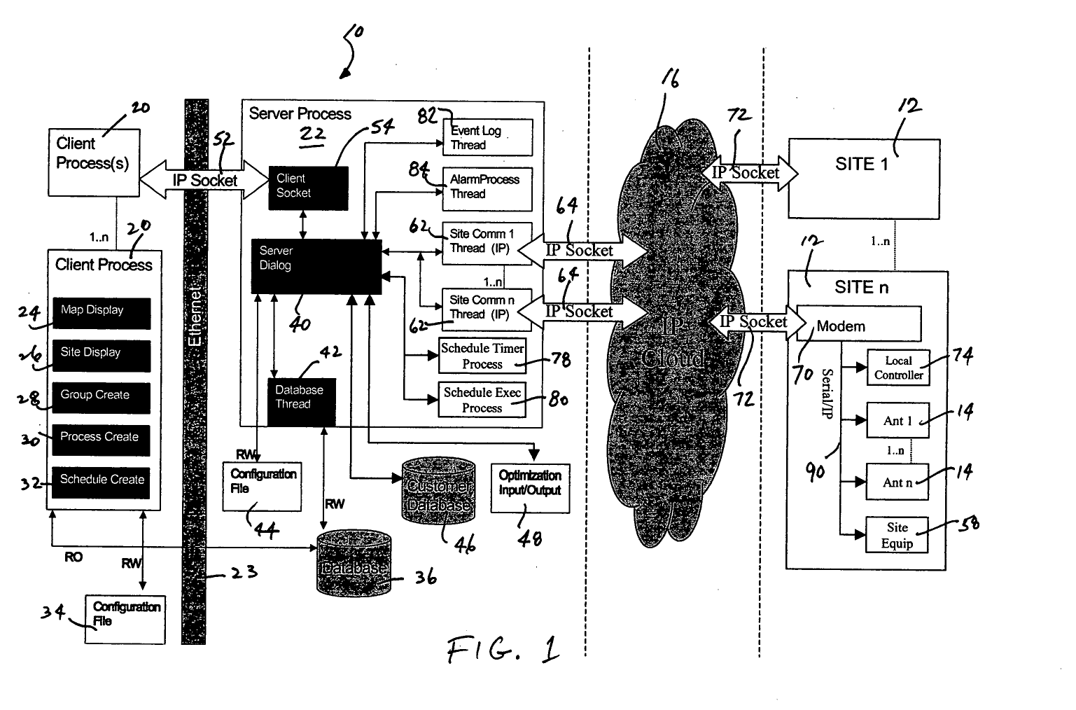

Referring to FIG. 1, the present wireless communications network management system is illustrated, and is generally identified by the numeral 10. System 10 is stand-alone, client/server, internet protocol (IP) based network management system utilized for automatically and dynamically monitoring and controlling a network of base station antennas and cell site equipment located at a plurality of sites 12 located remotely from system 10. Each site 12 includes a plurality of antennas 14 which are individually controlled by system 10. System 10 communicates with sites 12 and antennas 14 via a data network 16 illustrated as an IP cloud. An important aspect of the present invention is that system 10 generates an IP address and establishes an IP connection to data network 16 to communicate with sites 12, antennas 14 and other cell site equipment 58. Data network 16 represents a communication network, and may include, for example, and is not limited to, a conventional telephone network (POTS), a satellite communications system, cable broadcast system, a T1 digital transmission link and the internet. A combination of various types of communication systems may also be utilized in configuring data network 16 for communicating data between sites 12 and system 10 depending upon the type of equipment utilized at sites 12.

System 10 may be implemented as illustrated in FIG. 1, in a client/server architecture to allow for multiple users to access system 10. Multiple users or client process 20 represent computers, personal computers, terminals, desktop personal computers or workstations which communicate with a server process 22 computer via a local area network 23. Local area network 23 may comprise, for example, an Ethernet. Although system 10 is illustrated as being implemented in a client 20/server 22 architecture, it is understood that client process software and server process software can reside on a single computer where no local area network is utilized.

As will subsequently be described, client process 20 includes a graphical user interface (GUI) to allow multiple users to view multi-level map displays 24 for displaying local, regional, and countrywide network display and management of sites 12. Instantaneous and continuous feedback of network status is displayed on display 24. Additionally, the GUI includes a display 26 for displaying individual site 12 status, control and antenna 14 configurations. Group create display 28 allows the user to create and manipulate groups of antennas within a site 12 or multiple sites 12 for schedule processes and movement of numerous antennas 14 simultaneously.

Process create 30 is a user interface display to allow for the automated monitoring and positioning of groups of antennas for radiation pattern control by selecting elevation beam tilt, azimuth beam width, azimuth beam pointing, elevation beam width, azimuth beam shape and elevation beam shape. As used herein, these processes shall be collectively referred to as “antenna operating parameters”. Antenna operating parameters also include error conditions for access and movement, antenna power (input and reflected) and other parameters, such as, for example temperature. Schedule create display 32 allows a user to create and manipulate schedules which consists of processes and the time of day to execute a specific process created using display 30. A schedule consists of processes and the time of day to execute a specific process as well as the periodic nature of the process, such as a specific day of the week, or a one-time only configuration of a site 12 or multiple sites 12. Client process 20 accesses a configuration file 34 containing a database of predefined antenna operating parameter configurations for sites 12. Client process 20 also acts with a database 36 which includes data relating to specific sites 12.

Server process 22 provides for an interface between client processes 20 and data network 16 and includes a server dialog 40. Server dialog 40 represents software within server process 22. Dialog server 40 communicates with database 36 via a database thread 42 representing a series of computing instructions that comprise software within server process 22. Server dialog 40 also interfaces to a configuration file 44, customer database 46 and optimization input/output database 48. Configuration file 44 includes a database representing site 12 configurations. Customer database 46
includes data representing specific requirements of customers' operating sites 12. Optimization input/output database 48 represents antenna operating parameters developed by the use of customized software to provide a schedule for network optimization implemented by network 10.

Communication between client process 20 and server process 22 is established using a protocol over IP socket 52 which provides an input to server process 22 via a port or client socket 54. Server process 22 communicates with multiple clients 20 at any given time. At start up, server process 22 will issue an IP socket listen command. After successful operator login, client process 20 will direct a connect command to server process 22. Server process 22 will then perform an accept command, and add the client socket 54 to its list of logged-in client processes 20. Thus, a socket connection will be in place via local area network 23.

Communication across IP socket 52 will be performed, for example, using a private class-oriented protocol. The originator's computer name, message type and data will be passed with each message between client process 20 and server process 22. On receipt, the socket message is time-stamped. When a socket or port is closed from one side of local area network 23, the application on the other side will receive a “socket closed” notification, at which time the socket interface will be closed. When a client process 20 socket closes, server process 22 will remove that client from its list of logged-in clients. Client process 22 will no longer send messages to that client, nor will process 22 accept communication that indicates that it is from that client. When a client process 20 receives notification that the server socket has closed, client process 20 will provide feedback to the user. The status window of client process 20 will no longer accurately reflect network status, and no further configurations will be allowed.

Server process 22 functions as an interface and controller between sites 12 and users 20. Server process 22 controls activities at sites 12 including the control of antenna operating parameters as well as the control and monitoring of parameters associated with RF path devices such as, for example, low noise and power amplifiers, and site equipment 58 located at each site 12. Amplifier parameters include, such as, for example, gain, temperature and output power. Site equipment 58 may include, for example, power supplies, security devices, monitors, air conditioners, radios, weather instrumentation GSM devices, TI-interfaces, microwave backhaul systems, repeaters and pico cells. Server process 22 also is the access point through which users 20 travel in order to write to database 36 and access and edit configuration file 44.

For each instance of a point of communication between server process 22 of system 10 and a site 12 there is a dedicated thread 62 connected to dialog 40 to establish communication to and from a site 12. A site communication thread 62 exists for each site 12. A communication link in the form of an IP socket 64 is established to data network 16 from each thread 62. Server process 22, upon start up, will create a dedicated thread 62 with an IP socket 64 for each defined site 12.

Each site 12 includes a modem 70 which establishes a communication link via an IP socket 72 with data network 16. Modem 70 communicates serially or via an IP connection 90 to antennas 14 and site equipment 58 as well as a local controller 74. Connection 90 may include, for example, RS 232, RS 485, RS 422 or Ethernet connections which connection is device controlled and protocol independent. Once a site modem 70 has connected via data network 16 to server process 22, the server application authenticates the modem 70 to determine which site 12 has been connected. This process allows for simultaneous control and status of numerous sites 12.

Server process 22 has the capability to initiate communication between modem 70 at each site 12 and the server application. This process involves the service application utilizing a dial-up analog telephone line within data network 16 to call a modem 70. Anytime a modem 70 at any of the control sites 12 receives a telephone call, modem 70 will disconnect the analog telephone line and initiate the IP connection to server process 22. This process to force a connection to any particular site 12 can be generated by a user, or automatically done when server process 22 determines communication is necessary to a particular site 12.

Once a communication thread 62 has been created, and an IP socket connection 64 exists between server process 22 and a particular site 12 modem 70, the server application will begin to status and control all of the antennas 14 associated with that site 12, as well as other site equipment 58. All commands, designated for a specific antenna 14 or site equipment 58 are buffered for each individual site 12. After the site 12 has connected, the server process application will automatically status each antenna 14, and execute any commands that have been qued for each antenna 14. These commands include any antenna 14 position changes requested by the user or commands automatically entered from a scheduled process stored in schedule time process 78 and scheduled execution process 80. Server process 22 communicates with each antenna 14, and any other serial device at a site 12 through IP socket 64 initiated by modem 70. All alarms and status information are logged by server process 22 at threads 82 and 84, respectively. Server process 22 continuously tracks each and every IP socket 64 connection to determine which sites 12 have active connections. Any commands or requests of statistical information designated for a site 12 will automatically be processed if that site 12 has an active connection. If the designated site 12 is not active, the commands and/or requests will be buffered and await an active connection, at which time they will be automatically processed. When necessary, server process 22 will automatically dial-up a site 12 modem 70 to initiate the connection.

Server process 22 maintains a record of current and last time of communication with each site 12. This information is utilized to alarm sites 12 that have not initiated communication with server process 22 within a set period of time.

Schedule time process 78 maintains the date and time the next scheduled process is to be executed. Any changes to the databases 36, 46 and 48 will force server process 22 to reset the date and time of the next scheduled process. Server process 22 will interrupt at the date and time associated with the next scheduled process. This interrupt will force the server application to execute the specific process at schedule execute process 80. This process includes a group of antennas and the desired antenna positioning for each antenna which the user created at client process 20 via displays 28, 30 and 32. Server process 22 determines which sites have active connections, and begins positioning antennas 14 at the requested site 12. Those sites which do not have active connections, will have their new positions buffered and wait for their next connection. When necessary, as previously stated, server process 22 will initiate the connection through a dial-up analog line via data network 16 forcing the site 12 modem 70 to initiate an IP socket 72 connection.

Server process 22 allows for real-time network optimization. When placed in this mode, server process 22 will save all pertinent site 12 and antenna 14 information in a comma-delimited file. Optimization input/output database 48 determines the optimal position for an antenna based upon previously calculated network conditions. Server process 22 will in turn read a comma-delimited file, as prepared by optimization input/output database 48 detailing the optimal antenna positions. Server process 22 is configured to automatically implement the changes dictated by this optimization process or to implement the changes after a user confirmation. After positioning the antennas 14 to new angles, the user will have the capability to reset the network to a default configuration, or return to previous antenna 14 positions.

Network 10 will generate alarms as system events occur that require reporting via alarm process thread 84. Possible alarms are databased and configured with a security level. Generated alarms are sent to the system log and to all logged-in users. If the alarm is configured with a major or minor severity, the alarm will be added to the current alarm's database table as well. Alarm processing includes the following steps: (a) a system event occurs that requires an alarm to be generated; (b) the alarm is created and passed to the alarm type identification code, its source, the current time, and overriding alarm text; (c) a look up is performed into the alarm definition table to obtain the severity level of the alarm code and its default text; (d) the alarm is formatted and added to the system log; (e) the alarm is forwarded to all logged-in users; and (f) if the severity justifies, the alarm is added to the current alarm table.

A clear alarm is created through the following process: (a) an error situation clears that had caused an alarm to be generated; (b) a clear alarm is created and passed the original alarm type ID code, its source, the current time, and overriding alarm text if necessary; (c) a look up is performed in the alarm definition table to obtain the security level of the alarm code and its default text; (d) the clear alarm is formatted and added to the system log; (e) the clear alarm is forwarded to all logged-in users; and (f) if the severity of the original alarm justifies, the original alarm is removed from the current alarm table. The user at client process 20 can view current alarms and manually clear alarms. A window in site display 26 will display alarms. Severity levels or alarm definitions will be modified by changing database 36.

Event log thread 82 is a time-stamped history of alarms and events that have taken place within system 10. Each entry will include a date and time, the source of the event, and a description of the event. The types of events that will be logged include values, outside bounds and operator actions. The system log is archived on a periodic basis and when the log reaches a file size limit. Archived logs may be viewed. Both current and archived logs may be searched, filtered and printed. Event log thread 82 maintains a comma-delimited text file. At user initiation, when a system log is open, the log is initialized from this file. Thereafter, it is updated in real time as system log messages are received from server process 22.

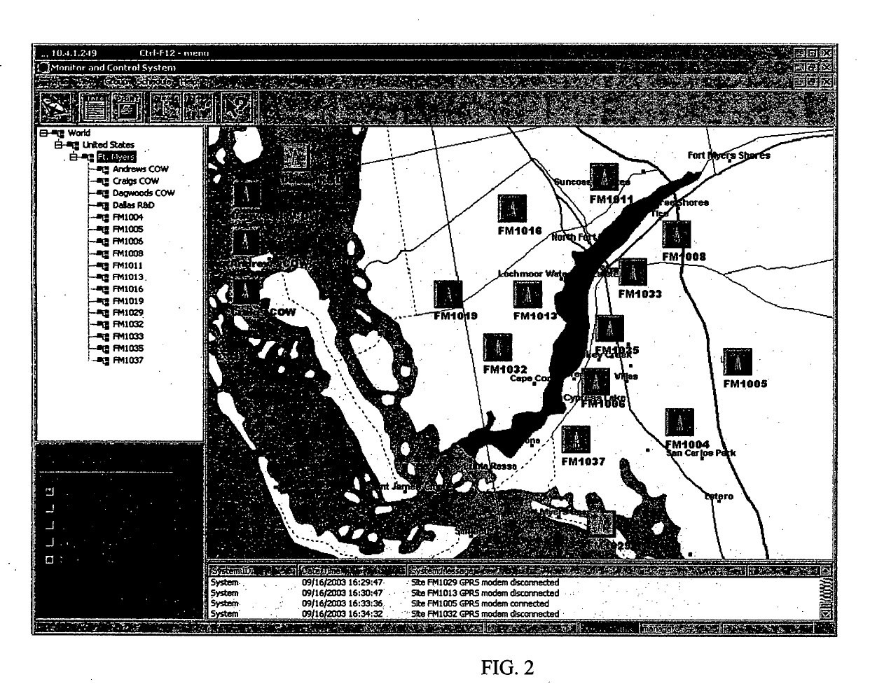

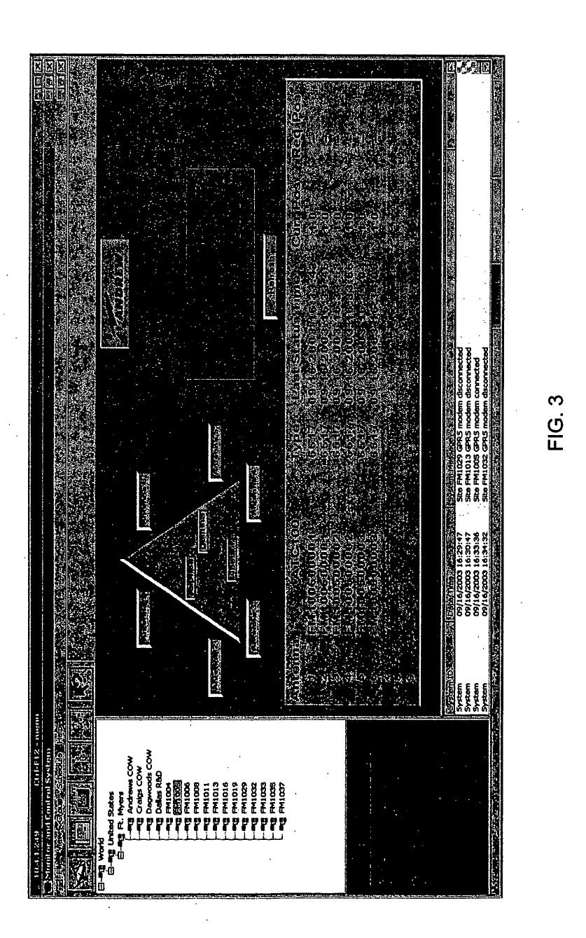

Client process 20 provides the user with a graphical user interface for network 10. FIGS. 2-7 illustrate top-level status window, site specific window and windows associated with creating groups, processes, events and schedules. Referring specifically to FIGS. 2 and 3, displays 24 and 26 (FIG. 1) are illustrated. FIG. 2 illustrates a map display 24 of an antenna network. A user can “drill-down” through various maps to a site 12. At each level of map display 24, color coded status icons depict the current status of sites 12 within the network. As the status changes, server process 22 will notify all users, so that current visual status is displayed in map display 24. The user can double click on a node/site on map display 24 or utilize the network tree illustrated on the left side of screen display in FIG. 2.

FIG. 3 illustrates a site display 26 in which a user can select any site 12 to view current configuration, position information and status of antennas 14 at that site. Once the user has selected a site 12, client process 20 will determine if the site 12 has an active connection. If the site does not have an active connection, system 10 will automatically dial that site to initiate the IP socket 64 communication process. The connection status is displayed on site display 26.

In addition to the connection status, site display 26 includes a table with antenna information. This information include antenna type, last time of communication, current position, and any outstanding positioning requests. If any antenna is in alarm condition, this information will also be displayed on site display 26. The user may select a specific antenna 14 within a site 12 or a specific sector of sites 12 for position movement. Once an antenna 14, or sector, has been commanded to a new position, the requested position will be displayed until the antenna 14 has been moved to that position, at which time the requested position field is cleared, and the current position field is updated to the new position.

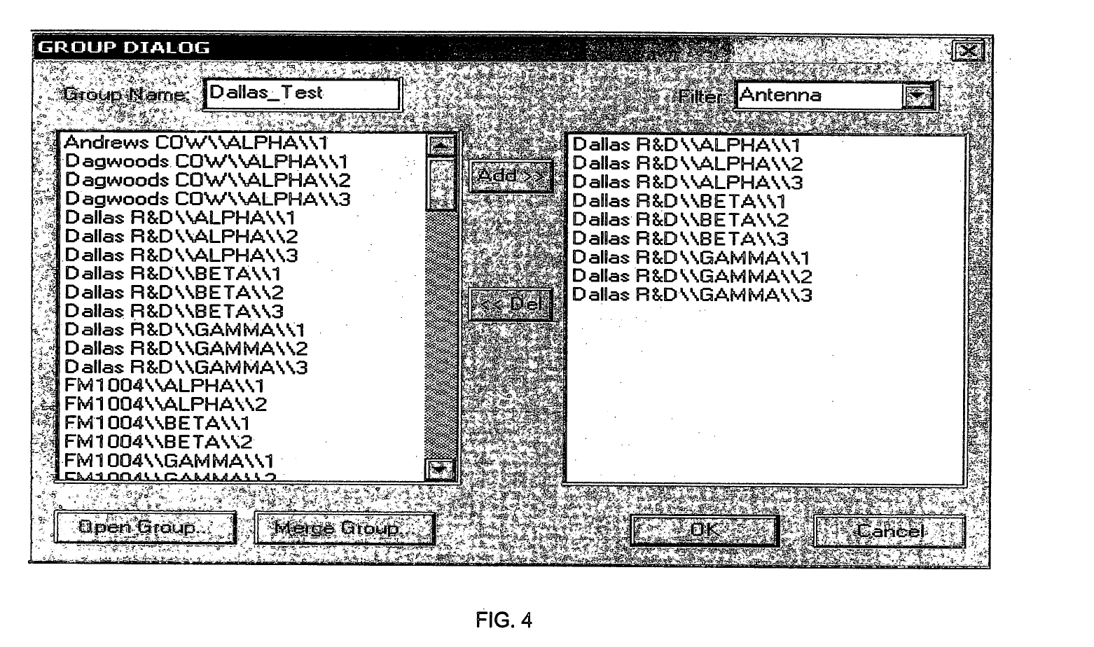

System 10 allows for the creation of a group of antennas 14 for controlling numerous antennas automatically. FIG. 4 illustrates process create display 30 to allow a user to create antenna groups by site 12, group of sites 12 or individual antennas 14. The user may add, delete or modify the groups as needed. Once a group of antennas has been created, the group may be used in a process to execute numerous antenna movements simultaneously.

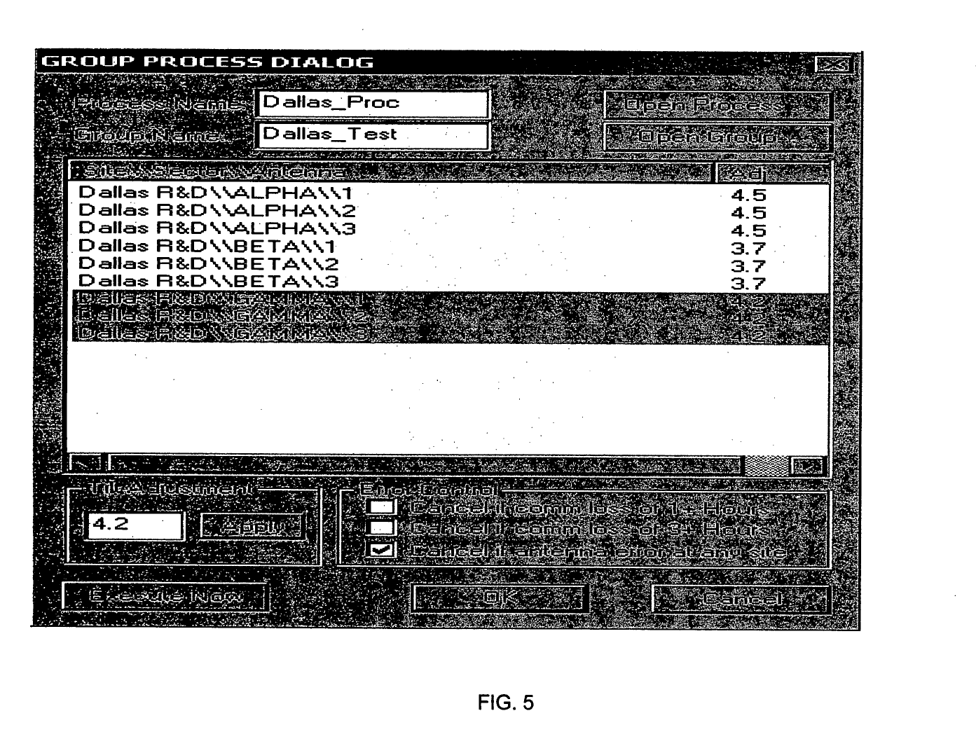

System 10 allows for a user to schedule a group process using process create display 30 as shown in FIG. 5. A group process includes a group of antennas 14 which have a designated beam elevation position. In addition to the request beam elevation position, there are conditional access and alarm conditions that apply to the specific group process. The user may highlight a specific antenna 14 or a combination of antennas 14 and input a requested antenna operating parameter. Once the group process has been created, the process may be placed in a schedule for automated execution or to be manually executed by the user.

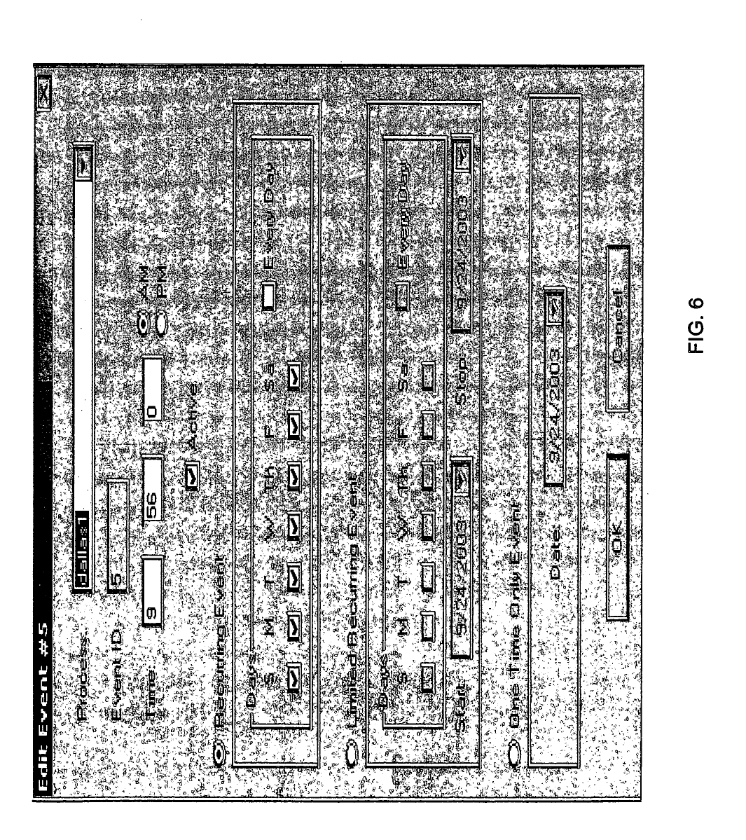

Once the group has been created by display 28 and the process created by display 30, a schedule may be created via display 32 as illustrated in FIG. 6. The group process may be scheduled for automatic execution. The options for scheduling include a one-time only execution with a corresponding date and time, a recurring execution or a limited recurring execution. FIG. 6 illustrates display screen 32 including the selection of a recurring event based upon day of week, a limited recurring event based upon day of week or a one-time event including a start and stop time associated with each day. Upon recurring and limited recurring, the user may select daily, or any combination of days, with date/time, for execution. The limited recurring option contains an end date/time when the process will automatically be removed from the schedule. The user can view the entire schedule. Any time the schedule is altered, server process 22 is notified, so that a new interrupt value can be computed. The schedule is executed via schedule execute process 80 within server process 22.

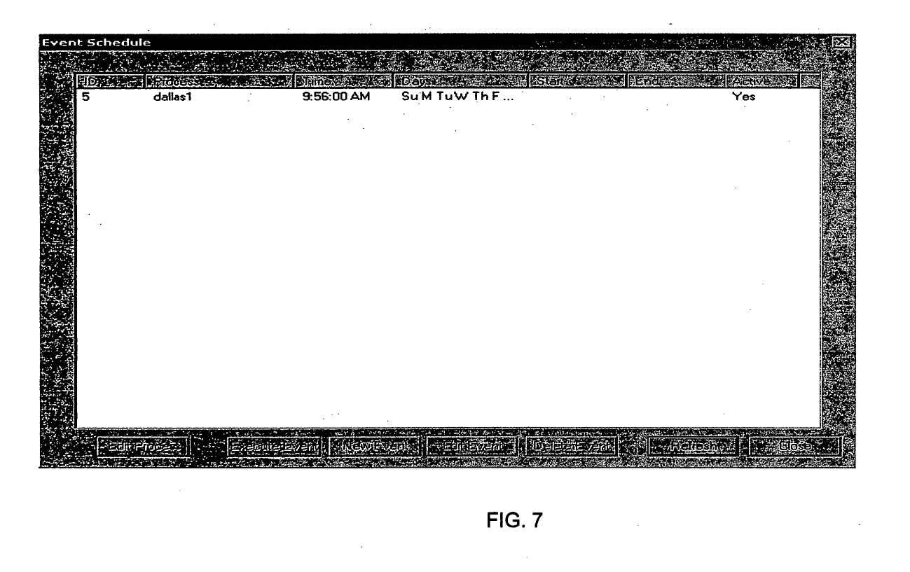

FIG. 7 illustrates a display screen showing an event schedule after creation of schedule using display screen 32. Any outstanding requests to a specific antenna 14 will have visual feedback to the user. If any antenna 14 at a specific site 12 has an outstanding request, the site icon (FIG. 2) displayed via map display 24 will be color-coded to depict that there are outstanding requests at a site 12.

Antenna parameter control for antennas 14 is performed utilizing an antenna control system such as described in U.S. Pat. No. 6,198,458 entitled “Antenna Control System” which description and drawings are hereby incorporated by reference. Such an antenna control system enables the control of antenna beam tilt and other antenna operating parameters as described herein.

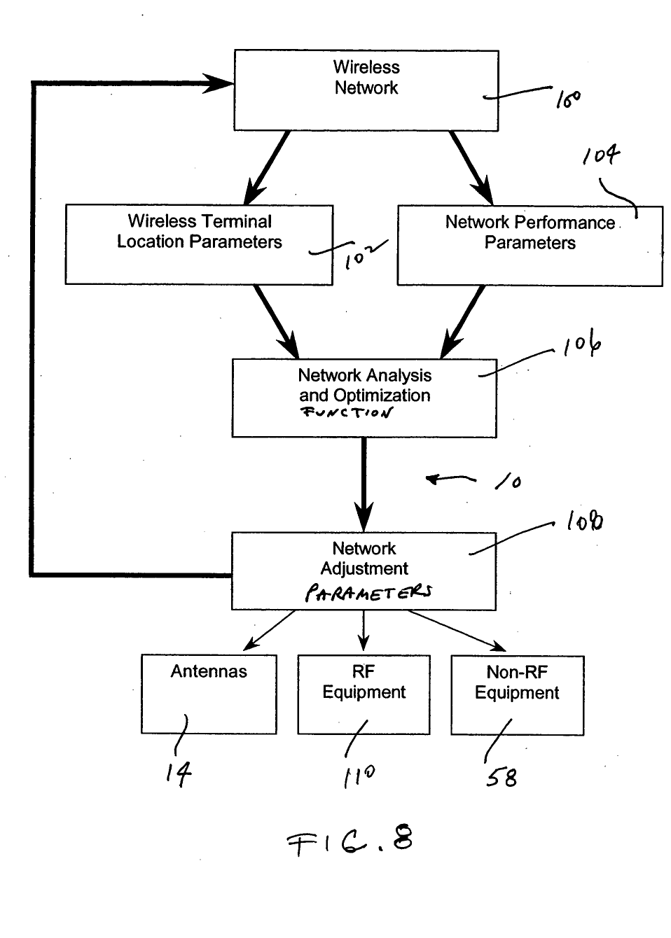

Referring now to FIG. 8, as previously stated, system 10 comprises a network management system for automatically and dynamically monitoring and controlling a wireless network, such as for example, a network of base station antennas and cell site equipment. System 10 further performs system optimization in an open loop, broken loop, and closed loop configuration. Wireless network 100, such as for example, the present network of base station antennas operation is defined by wireless terminal location parameters 102 and network performance parameters 104. System 10, utilizing parameters 102 and 104, performs a network analysis and optimization function 106 and generates network adjustment parameters 108 to antennas 14, RF equipment 110 and non-RF equipment 58 located at cell sites 12. The network adjustment parameters 108 generated by system 10 result in adjustments to wireless network 100. Optimization occurs on an open loop configuration in which specific antenna operating parameters are changed based upon remote manual changes or defined scheduled changes previously programmed into system 10. Optimization also results based on a broken loop configuration in which change tables are loaded into system 10 utilizing optimization input/output 48 (FIG. 1) which represents antenna operating parameters and traffic parameters such as capacity information and hand-over statistics which have been developed by the use of customized software. This type of optimization of network 100 is made on a scheduled basis. A closed loop configuration operates network 100 and modifies network performance parameters 104 on a real time feedback basis, such that as network adjustment parameters 108 control antennas 14, RF equipment 110 and non-RF equipment 58 at cell sites 12. The operation of these devices after adjustment, is continuously analyzed by network analysis and optimization function 106 of network 10 to continuously provide network adjustment. Closed loop optimization also provides for use of mobile location parameters of mobile operators within the wireless network 100 as well as network parameters and traffic parameters.

Other alteration and modification of the invention will likewise become apparent to those of ordinary skill in the art upon reading the present disclosure, and it is intended that the scope of the invention disclosed herein be limited only by the broadest interpretation of the appended claims to which the inventor is legally entitled.

1. A network management system for controlling a network of antennas including multiple antennas located on multiple sites, each of the antennas having antenna operating parameters, the system comprising:
a controller remotely located from the multiple sites of the network of antennas for generating an IP address and establishing an IP connection to a data network in communication with the network of antennas and for providing control signals to selected antennas in the network of antennas over said IP connection; and
a user interface coupled to said controller for selecting antennas within the network of antennas and for controlling using said control signals selected antenna operating parameters of said selected antennas.

2. The system of claim 1 wherein said user interface includes:
process control for establishing groups of antennas in the antenna network for simultaneously changing antenna operating parameters of all antennas within a group.

3. The system of claim 1 wherein said user interface includes:
process control for changing a selected antenna operating parameter for a group of antennas located at a site.

4. The system of claim 1 wherein said user interface includes:
process control for establishing a group of antennas in the antenna network for simultaneously changing antenna operating parameters of all antennas within the group;
process control for selecting an antenna operating parameter to be changed by said controller; and
process control for automatically scheduling execution of said antenna operating parameter changes for the antennas in the group of antennas.

5. The system of claim 1 and further including a local area network interconnecting said controller and said user interface.

6. The system of claim 1 wherein said user interface includes a graphic display for displaying a representation of the network of antennas.

7. The system of claim 1 wherein said user interface includes a graphic display for displaying selected antenna operating parameters of selected antennas within the network of antennas.

8. The system of claim 1 wherein said user interface includes a graphic display for displaying antenna operating parameters of antennas at selected sites within the network of antennas.

9. The system of claim 1 wherein said user interface includes a graphic display for displaying user selected groups of antennas within the network of antennas.

10. The system of claim 1 wherein said user interface includes a graphic display for displaying user selected antenna operating parameters for selected groups of antennas within the network of antennas.

11. The system of claim 1 wherein said user interface includes a graphic display for displaying user created schedules for controlling selected antenna operating parameters of selected antennas within the network of antennas.

12. The system of claim 1 wherein said user interface includes:
a first graphic display for displaying a representation of the network of antennas;
a second graphic display for displaying selected antenna operating parameters of selected antennas within the network of antennas;
a third graphic display for displaying antenna operating parameters of antennas at selected sites within the network of antennas;
a fourth graphic display for displaying user selected groups of antennas within the network of antennas;
a fifth graphic display for displaying user selected antenna operating parameters for selected groups of antennas within the network of antennas; and
a sixth graphic display for displaying user created schedules for controlling selected antenna operating parameters of selected antennas within the network of antennas.

13. A base station telecommunications system comprising:
a plurality of antenna sites;
a plurality of antennas located a each of said plurality of antenna sites, each of said plurality of antennas having antenna operating parameters;
a data network in communication with said plurality of antenna sites;
a processor remotely located from said plurality of antenna sites for generating an IP address and establishing an IP connection to said data network for providing processor generated control signals to selected antennas over said IP connection for changing said antenna operating parameters; and
a user interface coupled to said processor for selecting antennas and selecting antenna operating parameters of said selected antennas to be changed.

14. The system of claim 13 wherein said antenna operating parameters are selected from the group consisting of elevation beam tilt, azimuth beam width, azimuth beam pointing, elevation beam width, azimuth beam shape and elevation beam shape.

15. The system of claim 13 wherein said user interface includes:
process control for establishing groups of antennas for simultaneously changing antenna operating parameters of all antennas within a group.

16. The system of claim 13 wherein said user interface includes:
process control for changing a selected antenna operating parameter for a group of antennas located at a site.

17. The system of claim 13 wherein said user interface includes:
process control for establishing a group of antennas for simultaneously changing antenna operating parameters of all antennas within the group;
process control for selecting an antenna operating parameter to be changed by said processor; and
process control for automatically scheduling execution of said antenna operating parameter change for the antennas in the group of antennas.

18. The system of claim 13 and further including a local area network interconnecting said processor and said user interface.

19. The system of claim 18 wherein said user interface includes a plurality of user interfaces for allowing multiple users access to said local area network.

20. The system of claim 13 wherein said user interface includes:
a first graphic display for displaying a representation of the network of antennas;
a second graphic display for displaying selected antenna operating parameters of selected antennas within the network of antennas;
a third graphic display for displaying antenna operating parameters of antennas at selected sites within the network of antennas;
a fourth graphic display for displaying user selected groups of antennas within the network of antennas;
a fifth graphic display for displaying user selected antenna operating parameters for selected groups of antennas within the network of antennas; and
a sixth graphic display for displaying user created schedules for controlling selected antenna operating parameters of selected antennas within the network of antennas.

21. The system of claim 13 wherein said processor generating control signals for controlling antenna equipment located at said antenna sites.

22. A method for controlling a network of antennas including multiple antennas located on multiple sites, each of the antennas having operating parameters, the method comprising:
generating using a controller remotely located from the multiple sites of the network of antennas an IP address and establishing an IP connection to a data network in communication with the network of antennas and providing control signals to selected antennas in the network of antennas over the IP connection; and
selecting antennas within the network of antennas using an interface coupled to the controller for controlling selected antenna operating parameters of the selected antennas by the control signals.

23. The method of claim 22 and further including:
establishing groups of antennas in the antenna network for simultaneously changing antenna operating parameters of all antennas within a group.

24. The method of claim 22 and further including:
changing a selected antenna operating parameter for a group of antennas located at a site.

25. The method of claim 22 and further including:
establishing a group of antennas in the antenna network for simultaneously changing antenna operating parameters of all antennas within the group;
selecting an antenna operating parameter to be changed by the controller; and
automatically scheduling execution of the antenna operating parameter changes for the antennas in the group of antennas.

26. The method of claim 22 and further providing a local area network interconnecting the controller and the interface.

27. The method of claim 22 and further including:
displaying a representation of the network of antennas on a display.

28. The method of claim 22 and further including:
displaying selected antenna operating parameters of selected antennas within the network of antennas on a display.

29. The method of claim 22 and further including:
displaying antenna operating parameters of antennas at selected sites within the network of antennas on a display.

30. The method of claim 22 and further including:
displaying user selected groups of antennas within the network of antennas on a display.

31. The method of claim 22 and further including:
displaying user selected antenna operating parameters for selected groups of antennas within the network of antennas on a display.

32. The method of claim 22 and further including:
displaying user created schedules for controlling selected antenna operating parameters of selected antennas within the network of antennas on a display.

33. The method of claim 22 and further including:
displaying on a display a representation of the network of antennas;
displaying on the display selected antenna operating parameters of selected antennas within the network of antennas;
displaying on the display antenna operating parameters of antennas at selected sites within the network of antennas;
displaying on the display user selected groups of antennas within the network of antennas;
displaying on the display user selected antenna operating parameters for selected groups of antennas within the network of antennas; and
displaying on the display user created schedules for controlling selected antenna operating parameters of selected antennas within the network of antennas.

34. A method for controlling base station telecommunications comprising:
providing a plurality of antenna sites;
providing a plurality of antennas located a each of the plurality of antenna sites, each of the plurality of antennas having antenna operating parameters;
connecting a data network to the plurality of antenna sites;
generating using a processor remotely located from the plurality of antenna sites an IP address and establishing an IP connection to the data network for providing processor generated control signals to selected antennas over the IP connection for changing the antenna operating parameters; and
selecting antennas and selecting antenna operating parameters of the selected antennas to be changed using an interface coupled to the processor.

35. The method of claim 34 wherein the antenna operating parameters are selected from the group consisting of elevation beam tilt, azimuth beam width, azimuth beam pointing, elevation beam width, azimuth beam shape and elevation beam shape.

36. The method of claim 34 and further including:
establishing groups of antennas for simultaneously changing antenna operating parameters of all antennas within a group.

37. The method of claim 34 and further including:
changing a selected antenna operating parameter for a group of antennas located at a site.

38. The method of claim 34 and further including:
establishing a group of antennas for simultaneously changing antenna operating parameters of all antennas within the group;
selecting an antenna operating parameter to be changed by the processor; and
scheduling execution of the antenna operator parameter change for the antennas in the group of antennas.

39. The method of claim 34 and further providing a local area network interconnecting the processor and the user interface.

40. The method of claim 34 further including:
allowing multiple users access to said local area network.

41. The method of claim 34 and further including:
displaying on a display a representation of the network of antennas;
displaying on the display selected antenna operating parameters of selected antennas within the network of antennas;
displaying on a display antenna operating parameters of antennas at selected sites within the network of antennas;
displaying on the display user selected groups of antennas within the network of antennas;
displaying on the display user selected antenna operating parameters for selected groups of antennas within the network of antennas; and
displaying on the display user created schedules for controlling selected antenna operating parameters of selected antennas within the network of antennas.

42. The method of claim 34 and further including:
controlling antenna equipment located at the antenna sites using the control signals.

43. A wireless network management system for controlling a network including multiple antennas and equipment located on multiple sites, each of the antennas having antenna operating parameters, the system comprising:
a controller remotely located from the multiple sites for generating an IP address and establishing an IP connection to a data network in communication with the sites and for providing control signals to selected antennas and equipment over said IP connection;
a user interface coupled to said controller for selecting antennas and for controlling using said control signals selected antenna operating parameters of said selected antennas; and
process control for optimizing operation of the network based upon antenna operating parameters and network performance.

44. The system of claim 43 wherein said user interface includes:
process control for establishing groups of antennas for simultaneously changing antenna operating parameters of all antennas within a group.

45. The system of claim 43 wherein said user interface includes:
process control for changing a selected antenna operating parameter for a group of antennas located at a site.

46. The system of claim 43 wherein said user interface includes:
process control for establishing a group of antennas for simultaneously changing antenna operating parameters of all antennas within the group;
process control for selecting an antenna operating parameter to be changed by said controller; and
process control for automatically scheduling execution of said antenna operating parameter changes for the antennas in the group of antennas.

47. The system of claim 43 and further including a local area network interconnecting said controller and said user interface.

48. The system of claim 43 wherein said user interface includes a graphic display for displaying a representation of the network of antennas.

49. The system of claim 43 wherein said process control for optimizing network operation includes a prestored database of antenna operating parameters for use by said controller for generating said control signals.

50. The system of claim 43 wherein said process control for optimizing network operation includes process control for monitoring the network in real time and providing said controller antenna operating parameters in real time to said controller.

51. The system of claim 43 wherein said user interface includes:
a first graphic display for displaying a representation of the network of antennas;
a second graphic display for displaying selected antenna operating parameters of selected antennas within the network of antennas;
a third graphic display for displaying antenna operating parameters of antennas at selected sites within the network of antennas;
a fourth graphic display for displaying user selected groups of antennas within the network of antennas;
a fifth graphic display for displaying user selected antenna operating parameters for selected groups of antennas within the network of antennas; and
a sixth graphic display for displaying user created schedules for controlling selected antenna operating parameters of selected antennas within the network of antennas.

52. A method for controlling a wireless network including multiple antennas and equipment located on multiple sites, each of the antennas having operating parameters, the method comprising:
generating using a controller remotely located from the multiple sites an IP address and establishing an IP connection to a data network in communication with the sites and providing control signals to selected antennas and equipment over the IP connection; and
selecting antennas using an interface coupled to the controller for controlling selected antenna operating parameters of the selected antennas by the control signals; and
optimizing operation of the network based upon antenna operating parameters and network performance.

53. The method of claim 52 and further including:
establishing groups of antennas in the antenna network for simultaneously changing antenna operating parameters of all antennas within a group.

54. The method of claim 52 and further including:
changing a selected antenna operating parameter for a group of antennas located at a site.

55. The method of claim 52 and further including:
establishing a group of antennas in the antenna network for simultaneously changing antenna operating parameters of all antennas within the group;
selecting an antenna operating parameter to be changed by the controller; and
automatically scheduling execution of the antenna operating parameter changes for the antennas in the group of antennas.

56. The method of claim 52 and further providing a local area network interconnecting the controller and the interface.

57. The method of claim 52 and further including:
displaying a representation of the network of antennas on a display.

58. The method of claim 52 wherein optimizing operation of the network utilizes a prestored database of antenna operating parameters based upon calculated network operating parameters.

59. The method of claim 52 wherein optimizing operation of the network occurs in real time.

60. The method of claim 52 and further including:
displaying on a display a representation of the network of antennas;
displaying on the display selected antenna operating parameters of selected antennas within the network of antennas;
displaying on the display antenna operating parameters of antennas at selected sites within the network of antennas;
displaying on the display user selected groups of antennas within the network of antennas;
displaying on the display user selected antenna operating parameters for selected groups of antennas within the network of antennas; and
displaying on the display user created schedules for controlling selected antenna operating parameters of selected antennas within the network of antennas.
